(19) United States
(12) Patent Application Publication
(10) Pub. No.: US 2018/0238100 A1
(43) Pub. Date: Aug. 23, 2018

(54) CONTINUOUS POCKET TRIM BOARD SYSTEM

(71) Applicant: Tapco International Corporation, Wixom, MI (US)

(72) Inventors: Daniel B. Franklin, Monroe, OH (US); Clyde G. Allen, Lapeer, MI (US); Michael W. Maurer, Walled Lake, MI (US); Steven L. Brandemuehl, Canton, MI (US)

(73) Assignee: Tapco International Corporation, Wixom, MI (US)

(21) Appl. No.: 15/896,248

(22) Filed: Feb. 14, 2018

Related U.S. Application Data
(60) Provisional application No. 62/461,951, filed on Feb. 22, 2017.

(51) Int. Cl. E06B 1/68; E04F 19/02; E06B 1/34

(52) U.S. Cl. CPC E06B 1/68; E06B 2001/622; E06B 1/34; E04F 19/024

(57) ABSTRACT

A trim board is attachable to a mounting surface, and includes a base column extending therefrom. An attachment flange extends from the base column, adjacent to the mounting surface, toward a siding area. A cover ledge extends from the base column, offset from the mounting surface, toward the siding area. A pocket is defined between the cover ledge and the nailing flange, and extends continuously along the siding area and is configured to receive a siding element. The trim board includes an overhang member extending from the base column toward a wall opening defined through the mounting surface. A biscuit slot is defined in the overhang, extends continuously along the wall opening, and is configured to receive a biscuit tab. The attachment flange creates a first restraint point for the trim board, and the biscuit slot creates a second restraint point for the trim board.

### CROSS-REFERENCE TO RELATED APPLICATIONS

This application claims the benefit of U.S. Provisional Application No. 62/461,951, filed Feb. 22, 2017, which is hereby incorporated by reference in its entirety.

### INTRODUCTION

This disclosure generally relates to trim elements for siding, cladding, or roofing that is configured to cover walls of residential, commercial, or industrial buildings or structures. Exterior siding or cladding may be used to protect the walls of structures from the effects of weather and the ingress of moisture. Additionally, siding or cladding may provide aesthetic benefits. Border areas between the siding regions and openings or penetrations through the walls may be finished with trim elements.

### SUMMARY

A trim system or trim board attachable to a mounting surface is provided. The trim board may be located or disposed between a siding area and a wall opening defined in, or through, the mounting surface.

The trim board includes a base column and an attachment flange extending from the base column. A cover ledge extends from the base column, and is offset from the attachment flange. A pocket is defined between the cover ledge and the attachment flange. An overhang extends from the base column, and an insert opening is defined in the overhang. The insert opening is configured to receive an insert, such that the attachment flange creates a first restraint point, and the insert opening creates a second restraint point.

In some configurations, the trim board includes additional features. The trim board may have an anti-rotation tab extending from the base column, or a centerline of the trim board may pass through the base column, such that the anti-rotation tab and the attachment flange are on opposing sides of the centerline. The insert opening may define a biscuit thickness, which is substantially equal to a thickness of the attachment flange, such that trimmed portions of the attachment flange may act as inserts received into the insert opening.

The above features and advantages, and other features and advantages, of the present disclosure are readily apparent from the following detailed description of some of the best modes and other embodiments for carrying out the disclosure, which is defined solely by the appended claims, when taken in connection with the accompanying drawings.

### BRIEF DESCRIPTION OF THE DRAWINGS

FIG. 1 is a schematic, isometric view of a trim assembly and an illustrative siding element.

FIG. 2 is a schematic, isometric view of an uncut trim board, such as may be used in the trim assembly of FIG. 1.

FIG. 3 is a schematic, cross-section view of the trim assembly of FIG. 1, taken generally along a section or line 3-3.

FIG. 4 is a schematic, plan view of a trim assembly similar to that shown in FIG. 1, illustrating both mitered and square corners, and the pockets created thereby.

### DETAILED DESCRIPTION

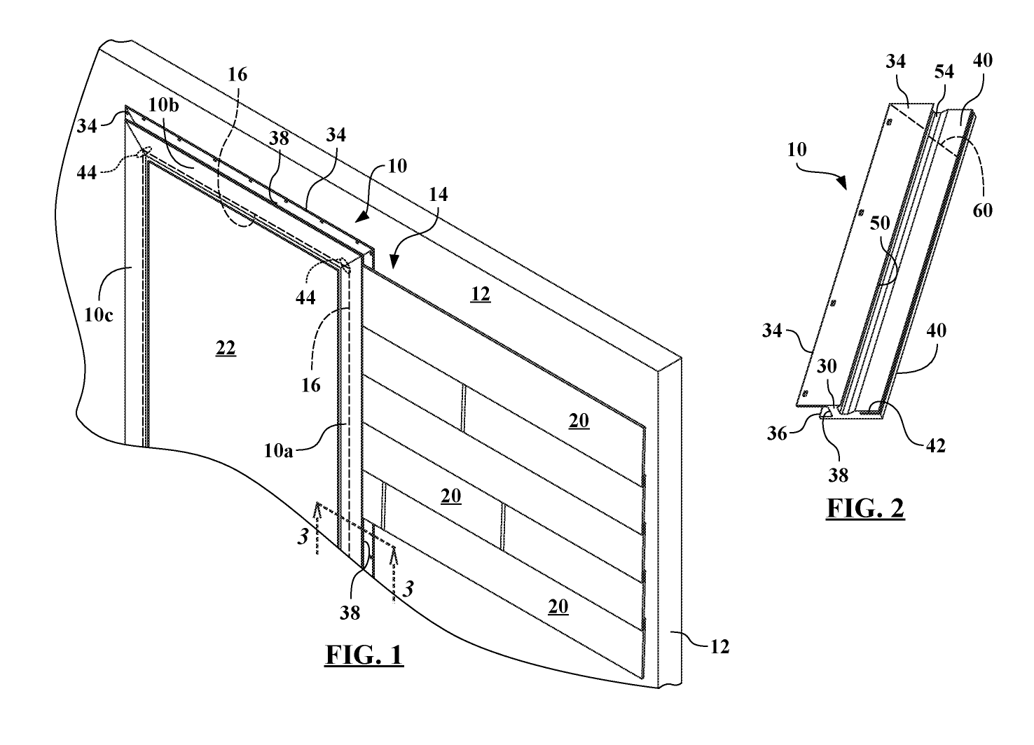

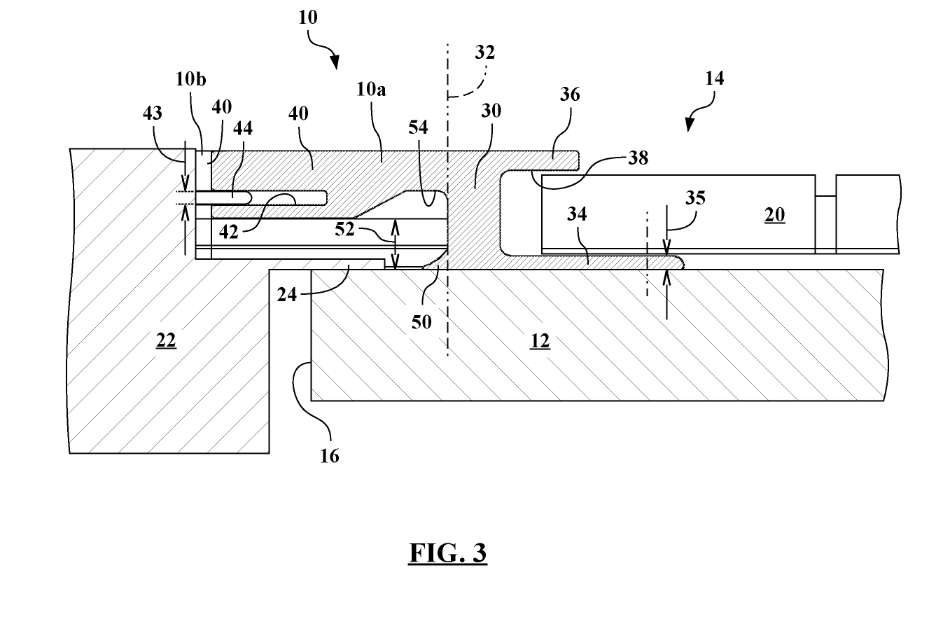

Referring to the drawings, like reference numbers correspond to like or similar components wherever possible throughout the several figures. FIG. 1 shows an illustrative portion of a trim system or trim assembly formed from at least one trim board 10. FIG. 2 shows a schematic isometric view of one of the trim boards 10 usable to assemble the trim system of FIG. 1. FIG. 3 shows a schematic cross-section view of the trim system of FIG. 1, taken generally along a line 3-3.

Reference to the figures and the general description is exemplary of the following features, embodiments, or configurations. A trim board attachable to a mounting surface between a siding area and a wall opening defined through the mounting surface. The trim board comprising a base column; an attachment flange extending from the base column; a cover ledge extending from the base column, offset from the attachment flange; a pocket defined between the cover ledge and the attachment flange; an overhang extending from the base column; and an insert opening defined in the overhang, wherein the insert opening is configured to receive an insert. Therefore, the attachment flange creates a first restraint point, and the insert opening creates a second restraint point.

Some configurations of the trim board may also include: an anti-rotation tab extending from the base column; a centerline of the trim board that passes through the base column, such that the anti-rotation tab and the attachment flange are on opposing sides of the centerline; or an overhang gap defined between the overhang and the mounting surface.

Additionally, the insert opening may define a biscuit thickness, which may be substantially equal to a thickness of the attachment flange. The overhang gap may be at least 0.5 inches in size or depth, and the pocket may be at least 0.5 inches in size or depth. In some configurations, the pocket extends continuously adjacent the siding area and is configured to receive a siding element; and the insert opening extends continuously adjacent the wall opening. The insert may be one of a biscuit, a dowel, a domino, a loose tongue, and a tenon.

In the embodiment or configurations illustrated in the figures, the trim boards 10—three of which are individually shown in FIGS. 1 and 3 as trim board 10a, trim board 10b, and trim board 10c, but all of which may be generically referred to as trim board 10—are attachable to a mounting surface 12. The trim boards 10 are located between a siding area 14, which covers at least a portion of the mounting surface 12, and a wall-opening side or wall opening 16, which is defined through the mounting surface 12.

Each of the trim boards 10 joins or marries a siding element 20, located on the siding area 14, to the wall opening 16 and the structure or structures filling the wall opening 16. In the configuration shown in the figures, a window unit 22 is disposed within the wall opening 16. However, for example and without limitation, doors, skylights, ventilation elements, or light boxes may also fill the wall opening in lieu of the window unit 22 illustrated.

FIG. 1 shows only a few siding elements 20, in order to better illustrate the features of the trim boards 10. However, in most installations, numerous siding elements 20 would abut, and may substantially surround, the trim boards 10. Some of the siding elements 20 are illustrated with keyways, such that those siding elements 20 simulate multiple elements or faces, and some are illustrated without keyways or with keyways not visible in the area shown.

The siding elements 20 cover the mounting surface 12 to provide aesthetic and functional benefits, including protection from ingress of water onto the mounting surface 12. The trim boards 10 are also configured to protect against ingress of water to the mounting surface 12 or through the wall opening 16, while also having aesthetic benefits, both individually and as transition elements between the siding elements 20 and the window unit 22.

The siding elements 20 interacting with the trim boards 10 may be numerous types of siding or roofing products. In the figures, the siding element 20 is generally representative of a panel that, when assembled to others, resembles the appearance of wooden shake siding, and may be formed of PVC, vinyl, or composite (including fiber cement) materials. However, the siding elements 20 may be other products, including, without limitation: natural wooden shakes or shingles; natural, artificial, or composite plank or lap siding; metal siding; wooden, slate, or asphalt shingles; or stone or brick veneer.

While the present disclosure may be illustrated with respect to particular industries or applications, those skilled in the art will recognize the broader applicability of the products and methods described herein. For example, similar structures, methods, or combinations thereof, may be used in other industries, including, without limitation: interior household trim or industrial structures.

Those having ordinary skill in the art will also recognize that terms such as “above,” “below,” “upward,” “downward,” et cetera, are used descriptively of the figures, and do not represent limitations on the scope of the appended claims. Any numerical designations, such as “first” or “second” are illustrative only and are not intended to limit the scope of the claims in any way.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting of the claims or the description.

While the description focuses largely on siding applications, in which the mounting surface 12 is generally vertical, the trim board 10 may also be used for roofing applications, in which the mounting surface is angled, or combinations thereof. Therefore, the siding area 14 is also representative of roof portions and the wall opening 16 is also representative of roof openings. Note that FIG. 2 shows the reverse side, relative to the viewpoint of FIG. 1, of the trim board 10.

In the configuration shown, the window unit 22 includes a window flange 24 extending over a portion of the mounting surface 12. However, other configurations may lack the window flange 24, such that the window unit 22 is within the wall opening 16 and does not extend over the mounting surface. For example, a door casing may be disposed within the wall opening 16 without having any flange extending from the casing over the mounting surface 12.

As best viewed in FIG. 3, the trim board 10 has a base column 30 extending away from the mounting surface 12. In the configuration shown, a centerline 32 of the trim board 10 passes through the base column 30. The centerline 32 is an approximate halfway point between the left and right (as viewed in FIG. 3) edges of the trim board 10.

The trim boards 10 may be manufactured by, without limitation, extrusion or molding. The materials used may include, without limitation, polymers or composites (such as fiber-filled or fiber-cement products), and may be cellular or foamed.

An attachment flange 34, nail flange, or simply flange, extends from the base column 30, adjacent the mounting surface 12, toward the siding area 14. A plurality of fasteners (not shown), such as nails, screws, or staples, may be used to attach the attachment flange 34 to the mounting surface. Adhesives may also be used to fasten the attachment flange 34 to the mounting surface. The fasteners may pierce the attachment flange 34, as illustrated by a dashed pierce line in FIG. 3, may utilize predefined holes, as illustrated in FIGS. 1 and 2, or combinations thereof, such as marked or partially-defined holes. The attachment flange 34 defines a flange thickness 35.

A cover ledge 36 also extends from the base column 30, offset from the mounting surface 12, toward the siding area 14. The cover ledge 36 and the attachment flange 34 define a pocket 38 there between. The pocket 38 extends continuously along the siding area 14 and is configured to receive the siding elements 20. The pocket 38 covers cut edges or portions of the siding elements 20, such that it replaces a J-channel element that may, alternatively, be used to cover edges of the siding elements 20. When assembled or installed, the siding element 20 overlaps the attachment flange 34 and is covered by the cover ledge 36, such that it is within a portion of the pocket 38. In some configurations, the pocket 38 may define at least 0.5 inches of space, depth, or offset between the cover ledge 36 and the attachment flange 34.

An overhang member or overhang 40 extends from the base column 30 toward the wall opening 16, such that the overhang 40 is on the opposite side of the base column 30 from the pocket 38. The overhang 40 may be referred to as a cantilevered element, because there are no additional portions of the trim board 10 supporting the overhang 40.

An insert opening, tab channel, or biscuit slot 42 is defined in the overhang 40, and defines a tab thickness or biscuit thickness 43. The biscuit slot 42 extends continuously along the length of the trim board 10 facing, or adjacent to, the wall opening 16 and the window unit 22. The biscuit slot 42 is configured to receive an insert, biscuit tab, or insert tab 44. Furthermore, the insert tab 44 can span between the biscuit slots 42 of two, adjacent and abutting, trim boards 10, such as between the trim board l0a and the trim board 10b. The insert tab 44 may be, for example and without limitation: a biscuit, dowel, domino, loose tongue, or tenon.

When the trim boards 10, such as the trim board l0a and the trim board 10b, are joined to the mounting surface 12, the attachment flange 34 creates a first restraint point for the trim board 10. When the trim boards 10, such as the trim board l0a and the trim board 10b, are joined to one another, the biscuit slot 42 creates a second restraint point for the trim board 10.

As used herein, restraint points are structures or structural-interactions that limit movement of the trim board 10 relative to adjacent structures—for example, in the configuration shown, relative to the mounting surface 12, the window unit 22, or adjacent trim board 10 sections. Therefore, when installed, the trim board 10 is restrained from movement, and stabilized, at points on both sides of the base column 30 and, also, both sides of the centerline 32.

The inclusion of the first restraint point and the second restraint point enables mitered corners and promotes alignment of trim boards 10 that are adjacent to one another. Mitered corners may often be cut at 45-degree angles, but may be any other angled cuts on at least one end of the trim boards 45. Without two restraint points, adjacent trim boards 10 may otherwise drift slightly due to pressure or force imbalances causing dissimilar alignment. In particular, without the second restraint point created by the interaction between the biscuit slot 42 and the insert tab 44, there may be a misalignment at the mitered corners, particularly when uneven stresses are applied to the base column 30 or the attachment flange 34 of either adjacent trim board 10. Any misalignment may negatively affect both the aesthetics and function of the trim boards 10, as portions of the overhand 40 on adjacent trim boards 10 will be slightly offset from one another.

The mitered corners joining the trim board 10 also enable the pocket 38 to continuously extend around at least three sides of the wall opening 16. The continuous pocket 38 promotes redirection or diversion of water around the wall opening 16 via the trim boards 10.

Alternatively, the second restraint point may be achieved by cutting a biscuit pocket (not shown) only at the mitered corners of the trim boards 10. Because the trim boards 10 are generally cut to length on the job site, at the time of installation, this technique requires that the biscuit pockets also be cut at the job site, such as with a biscuit cutter, by an installer. Therefore, using biscuit pockets, instead of the continuous biscuit slot 42, adds additional on-site steps, time, and equipment needs. Furthermore, the trim board 10 would include additional material, and weight, per any given length, as the continuous biscuit slot 42 would be filled with material.

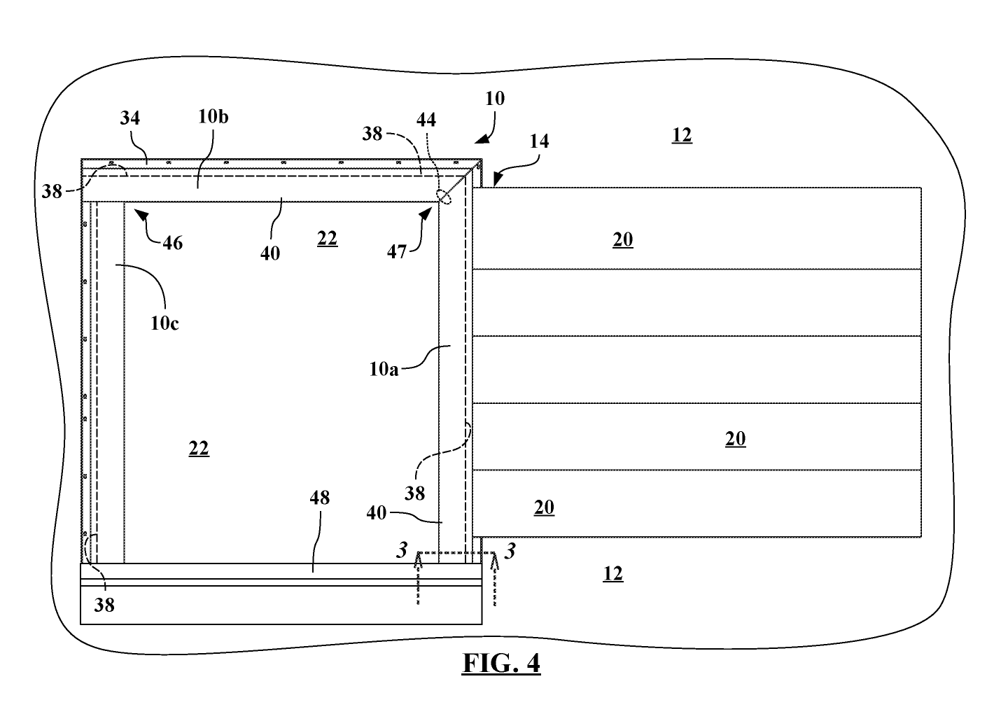

Referring also to FIG. 4, and with continued reference to FIGS. 1-3, there is shown an alternative view or configuration of the trim assembly, also including the trim boards 10a, 10b, and 10c. On the left side of FIG. 4, at a first intersection 46, the trim board 10c and the trim board 10b illustrate a square intersection, as opposed to a mitered corner. On the right side of FIG. 4, at a second intersection 47, the trim board 10a and the trim board 10b illustrate the mitered intersection, which is enabled by the insert tab 44 (shown in dashed lines in FIG. 4) and the biscuit slot 42 (not viewable in FIG. 4). Both of the joints illustrated in FIG. 1 are like the second intersection 47. Note that the first intersection 46 may not include any insert tab 44.

The pockets 38 are illustrated by dashed lines in FIG. 4. As shown on the right, the mitered corner at the second intersection 47 allows the pockets 38 to be continuous from the trim board 10b to the trim board 10a, such that there is continuous handoff and channeling of any moisture therein. However, on the left at the first intersection 46, there is a discontinuous channel caused by the square corner. Therefore, the ability to miter the corners of the trim boards 10, as provided by the two restraint points, promotes the continuous pocket 38 and moisture management benefits for the trim assembly.

In some configurations, the trim board 10 may continue around the entire wall opening 16, such that the pocket 38 continues for 360-degrees. However, in other configurations, such as that illustrated in FIG. 4, there may be sill or sill plate 48 at the bottom of the window unit 22. In the configuration shown, the pockets 38 end in a square fashion at the sill plate 48. Generally, water flows from the pockets 38 of the trim board 10c and the trim board l0a onto the sill plate 48, which is angled to carry that water away from the mounting surface 12.

As shown in FIGS. 2 and 3, the illustrated configuration of the trim board 10 includes an anti-rotation tab 50 that extends from the base column 30. The anti-rotation tab 50 is adjacent the mounting surface 12, and extends toward the wall opening 16. As illustrated in figures, the centerline 32 of the trim board 10 may pass through the base column 30, such that the anti-rotation tab 50 and the attachment flange 34 are on opposing sides of the centerline 32.

The anti-rotation tab 50 may counteract torque applied to the overhang 40 and limit rotation of the trim board 10 inward toward the wall opening 16. Therefore, the anti-rotation tab 50 further assists in maintaining alignment of adjacent trim boards 10 and promotion of mitered corners.

As best viewed in FIG. 3, the cantilevered overhang 40 allows the trim board 10 to extend to the window unit 22 without the window flange 24 rotating or pushing the trim board 10 away from the mounting surface 12. An overhang offset or overhang gap 52 is defined by the overhang 40 relative to the mounting surface 12.

The overhang gap 52 may be sized to assist installation. For example, where the thickness of the window flange 24 is expected to be approximately 0.1 inches, the overhang gap 52 may be approximately 0.6 inches, leaving one-half inches of space remaining between the window flange 24 and the overhang 40. In some configurations, filler material, gaskets, insulation, or precut trim spacers may be installed between the window flange 24 and the overhang 40, and these fillers may often be sized at one-half inches of thickness.

In the configuration shown, the trim board 10 also includes a relief cut or relief 54, which reduces the weight of the trim board 10 and further defines the cantilevered nature of the overhang 40. The relief 54 may also improve installation by opening up space for elements between the trim board 10 and the mounting surface 12 or window unit 22.

The biscuit slot 42 defines the biscuit thickness 43. In some configurations of the trim board 10, the biscuit thickness 43 of the biscuit slot 42 is substantially equal to the flange thickness 35 of the attachment flange 34. This enables trimmed pieces of the attachment flange 34, which may otherwise be considered waste and discarded, to be used as insert tabs 44 for joining the interior mitered corners of the trim boards 10.

In particular, when trim boards 10 are cut for mitering, there is an interior section that is removed and often discarded. The often-discard portion is illustrated in FIG. 2 by the portions beyond (upward, as viewed in FIG. 2) a miter line 60. Some portions of the attachment flange 34 from this interior section may be trimmed and used as the insert tab 44 for joining the mitered corners. Alternatively, separate biscuits, such as those made from wood or wood fibers, may be purchased and inserted for the insert tabs 44. However, using the waste portions of the attachment flange 34 reduces cost and eliminates the need to transfer and store separate biscuits.

The biscuit thickness 43 and the flange thickness 35 may be sized to meet standard dimensions of biscuits. For example, in the trim board 10 shown, the biscuit thickness 43 and the flange thickness 35 are approximately four millimeters, or 5/32 inches, which is generally equivalent to the thickness of a #0 biscuit.

The detailed description and the drawings or figures are supportive and descriptive of the disclosure. While some of the best modes and other embodiments for carrying out the disclosure have been described in detail, various alternative designs, configurations, and embodiments exist for practicing the appended claims.

1. A trim board attachable to a mounting surface between a siding area and a wall opening defined through the mounting surface, the trim board comprising:
a base column;
an attachment flange extending from the base column;
a cover ledge extending from the base column, offset from the attachment flange;
a pocket defined between the cover ledge and the attachment flange;
an overhang extending from the base column; and
an insert opening defined in the overhang, wherein the insert opening is configured to receive an insert,
such that the attachment flange creates a first restraint point, and the insert opening creates a second restraint point.

2. The trim board of claim 1, further comprising:
an anti-rotation tab extending from the base column.

3. The trim board of claim 2, wherein a centerline of the trim board passes through the base column, such that the anti-rotation tab and the attachment flange are on opposing sides of the centerline.

4. The trim board of claim 3, wherein the insert opening defines a biscuit thickness, which is substantially equal to a thickness of the attachment flange.

5. The trim board of claim 4, further comprising:
an overhang gap defined between the overhang and the mounting surface.

6. The trim board of claim 5, wherein the overhang gap is at least 0.5 inches in depth.

7. The trim board of claim 1, wherein the pocket is at least 0.5 inches in depth.

8. The trim board of claim 1, wherein the insert opening defines a biscuit thickness, which is substantially equal to a thickness of the attachment flange.

9. The trim board of claim 8, further comprising:
an overhang gap defined between the overhang and the mounting surface, wherein the overhang gap is at least 0.5 inches in depth.

10. The trim board of claim 1, wherein the pocket extends continuously adjacent the siding area and is configured to receive a siding element.

11. The trim board of claim 1, wherein the insert opening extends continuously adjacent the wall opening.

12. The trim board of claim 1, wherein the insert is one of a biscuit, a dowel, a domino, a loose tongue, and a tenon.

13. A trim system for attachment to a mounting surface between a siding area and a wall opening defined through the mounting surface, the trim system comprising:
a first trim board, having:
a base column extending away from the mounting surface;
an attachment flange extending from the base column, adjacent the mounting surface, toward the siding area;
a cover ledge extending from the base column, offset from the mounting surface, toward the siding area;
a pocket defined between the cover ledge and the nailing flange, wherein the pocket extends continuously adjacent the siding area and is configured to receive a siding element;
an overhang extending from the base column toward the wall opening; and
an insert opening defined in the overhang, wherein the insert opening extends continuously adjacent the wall opening and is configured to receive an insert tab;
a second trim board, having:
a base column extending away from the mounting surface;
an attachment flange extending from the base column, adjacent the mounting surface, toward the siding area;
a cover ledge extending from the base column, offset from the mounting surface, toward the siding area;
a pocket defined between the cover ledge and the nailing flange, wherein the pocket extends continuously adjacent the siding area and is configured to receive a siding element;
an overhang extending from the base column toward the wall opening; and
an insert opening defined in the overhang, wherein the insert opening extends continuously adjacent the wall opening and is configured to receive an insert tab; and
an insert tab joining the insert opening of the first trim board to the insert opening of the second trim board,
wherein the attachment flanges of the first trim board and the second trim board create first restraint points, and wherein the insert tab within the insert opening of the first trim board and the insert opening of the second trim board creates a second restraint point.

14. The trim system of claim 13,
wherein at least one end of the first trim board has a mitered cut,
wherein at least one end of the second trim board has a mitered cut, and
wherein the insert tab extends from the mitered cut of the first trim board to the mitered cut of the second trim board.

15. The trim board of claim 14, wherein the insert opening the first trim board and the second trim board define a biscuit thickness, which is substantially equal to a thickness of the attachment flange of the first trim board and the second trim board.
